(19) United States
(12) Patent Application Publication
(10) Pub. No.: US 2022/0158736 A1
(43) Pub. Date: May 19, 2022

(54) Optical Module and Method of Fabrication

(71) Applicant: Telefonaktiebolaget LM Ericsson (publ), Stockholm (SE)

(72) Inventors: Francesco Testa, Pisa (IT); Agneta Ljungbro, Bjärred (SE); Alberto Bianchi, Pisa (IT)

(21) Appl. No.: 17/432,959

(22) PCT Filed: Feb. 27, 2019
(86) PCT No.: PCT/EP2019/054863

§ 371 Date: Aug. 23, 2021

(51) Int. Cl. H04B 10/40; G02B 6/42; G02B 6/30

(52) U.S. Cl. CPC H04B 10/40; G02B 6/30; G02B 6/428; G02B 6/4245

(57) ABSTRACT

An optical module (100) comprising: a photonic integrated circuit, PIC, chip (102) having a surface layer and comprising at least one optical circuit; an electronic integrated circuit, EIC, chip (104) having a surface layer and comprising at least one electrical circuit; a molded substrate (106), wherein the PIC chip and the EIC chip are embedded in the molded substrate and the PIC chip is arranged with its surface layer generally at a first surface of the molded substrate; at least one redistribution layer, RDL, (108) located at the first surface of the molded substrate and having at least one opening (110) for receiving at least one optical fibre connection (208) to the PIC chip and at least one electrical connection with the PIC chip; at least one RDL (112) provided at a second surface of the molded substrate; and at least one electrical interconnection (114) between the RDLs at the first and second surfaces, through the molded substrate.

### TECHNICAL FIELD

The invention relates to an optical module and to a method of fabricating an optical module. The invention further relates to an antenna system, a baseband unit, and a packet switch unit.

### Background

Telecom and Datacom equipment are continuously increasing in data processing capacity and throughput, driven by traffic increases in data centres and in wireless networks. Next generation packet switch chips for server networking inside data centres will soon reach 12.8 Tbps capacity and 5G networks, with massive MIMO systems, will require Terabit/s throughput for fronthaul interconnection of the baseband processing unit to the antenna array.

For fast transfer of such high volumes of data out of high processing capacity digital application specific integrated circuits, ASICs, many high-speed input/output ports are needed at today's 25 Gbps data rate, and at 50 Gbps (and beyond) in the future.

Traditional electrical interconnects between ASICs and within printed circuit boards, PCBs, using high speed transmission lines are becoming more and more complex with data rate increases, due to frequency dependent loss generated by the skin effect in the copper traces and loss in the dielectric layers. The CEI-25G-LR standard limits the length of electrical interconnects on PCBs, at 25 Gbps data rate, to about 600 mm. For longer electrical PCB interconnects, complex modulation or signal regeneration along the path is required. Alternatively, coaxial cables have to replace high speed PCB lines to reduce loss. Both solutions increase hardware complexity and/or power consumption. At 50 Gbps data rate in PCB, electrical interfaces capable of reaching such long distances need Serializer/Deserializer, SERDES, that use PAM4 coding and forward error correction, FEC, along with powerful equalization circuits, and are complex and power consuming.

The use of optical multi-chip modules, OMCM, have been proposed by M. Romagnoli et al., “High bandwidth density optically interconnected Terabit/s Boards”, Proc. SPIE 10560, Metro and Data Center Optical Networks and Short-Reach Links, 30 Jan. 2018, to eliminate the bottleneck caused by the limited data rate*length product of electrical interconnects. M. Romagnoli et al propose that the interconnect between ASICs is performed by optical waveguides, that are nearly data rate and length independent.

An OMCM typically includes one or a few digital or analog ASICs tightly integrated with one or a few optical transceivers and electrically interconnected to them with an electrical interconnect having a length of a few mm. This reduces the electrical channel loss and allows the use of simple, non-return to zero, NRZ, coded low power interfaces. The optical transceivers are typically made by a photonic integrated circuit, PIC, chip including optical modulators, photodetectors and fiber couplers, and an electronic integrated circuit, EIC, including analog drivers and amplifiers to interface with the PIC. In such OMCMs, signal integrity, SI, performance is critical due to the very high transmission speed. To ensure high SI for high data rate signals, the length of the electrical interconnect between the ASICs and the EICs and between the EICs and the PICs must be kept as short as possible and the electrical lines must be with low capacitance and low inductance.

Three different types of integration techniques have been proposed for the implementation of OMCMs: 3D integration as described in F. Testa et al., “Integrated Reconfigurable Silicon Photonics Switch Matrix in IRIS Project: Technological Achievements and Experimental Results”, IEEE JLT; fan-out wafer level packaging, FOWLP, with backside optical I/O, as described in H. Uemura et al., “Backside Optical I/O Module for Si Photonics Integrated with Electrical ICs using Fan-Out Wafer Level Packaging Technology”, 2018 IEEE 68th Electronic Components and Technology Conference; and FOWLP with multi-chip stacking, as described in US 2017/0254968.

### SUMMARY

It is an object to provide an improved optical module. It is a further object to provide an improved method of fabricating an optical module. It is a further object to provide an improved antenna system. It is a further object to provide an improved baseband unit. It is a further object to provide an improved packet switch unit.

An aspect of the invention provides an optical module comprising a photonic integrated circuit, PIC, chip, an electronic integrated circuit, EIC, chip, a molded substrate, redistribution layers, RDLs, and at least one electrical interconnect. The PIC chip has a surface layer and comprises at least one optical circuit. The EIC chip has a surface layer and comprises at least one electrical circuit. The molded substrate has a first surface and a second surface. The PIC chip and the EIC chip are embedded in the molded substrate and the PIC chip is arranged such that its surface layer is generally at the first surface of the molded substrate. At least one redistribution layer, RDL, is provided, located at the first surface of the molded substrate. The PIC chip has at least one electrical connection with the at least one RDL. The at least one RDL has at least one opening provided through it for receiving at least one optical fibre connection to the PIC chip. At least one RDL is provided at the second surface of the molded substrate. At least one electrical interconnection is provided between the at least one RDL at the first surface and the at least one RDL at the second surface, the at least one electrical interconnection extending through the molded substrate.

The arrangement of the PIC chip within the optical module advantageously enables an optical fibre to be directly connected to the at least one optical circuit on the PIC chip, through the opening in the at least one RDL. This may enable reduced optical loss and better optical efficiency than the described prior art OMCMs in which optical signals are coupled to the back of a PIC chip, through the silicon substrate of the PIC chip. The optical module may have better SI than the described prior art OMCMs. The optical module may be fabricated at lower cost and using a simpler fabrication method than the described prior art OMCMs, with better mass producibility and yield.

In an embodiment, the PIC chip and the EIC chip are configured as an optical transceiver. The optical module may be used as an optical interconnection between electrical circuits, such as ASICs.

In an embodiment, the EIC chip is embedded in the molded substrate such that its surface layer is generally at the first surface of the molded substrate. The EIC chip has at least one electrical connection with the at least one RDL located at the first surface of the molded substrate. The at least one RDL located at the first surface of the molded substrate is configured to provide at least one electrical connection between the PIC chip and the EIC chip. Connecting the PIC and the EIC through the RDL advantageously enables a short electrical interconnection length and may enable better SI than the described prior art OMCMs.

In an embodiment, the EIC chip is embedded in the molded substrate such that its surface layer is at the second surface of the molded substrate. The EIC chip has at least one electrical connection with the at least one RDL located at the second surface of the molded substrate.

In an embodiment, the at least one RDL located at the first surface of the molded substrate has at least one opening provided through it at the PIC chip. The at least one opening is for receiving at least one optical fibre coupler of at least one optical fibre for carrying at least one optical data signal to or from the PIC chip. The at least one RDL at the first surface of the molded substrate has a further opening provided through it at the PIC chip for delivery of an optical carrier signal to the PIC chip. Advantageously, optical fibres for carrying data signals to and/or from the PIC chip and an optical fibre for delivering an optical carrier signal to the PIC chip can be directly connected to the at least one optical circuit of the PIC chip.

In an embodiment, the optical module further comprises a laser diode. The further opening in the at least one RDL at the first surface of the molded substrate is configured to locate the laser diode therein. The laser diode has an electrical connection to the at least one RDL at the first surface of the molded substrate and said at least one RDL is configured to provide an electrical connection between the laser diode and the EIC chip. A laser diode may advantageously be directly connected to the at least one optical circuit of the PIC chip and may be integrated within the optical module.

In an embodiment, the further opening is configured to receive a further optical fibre coupler of a further optical fibre for delivery of the optical carrier signal to the PIC chip. An optical carrier signal may be delivered directly to the at least one optical circuit of the PIC chip via an optical fibre connected to a remote optical carrier signal source. The optical source may advantageously be provided separate from the optical module.

In an embodiment, the optical module further comprises an application specific integrated circuit, ASIC, chip having a surface layer. The ASIC chip is embedded in the molded substrate such that the ASIC chip surface layer is generally at one of the first surface and the second surface of the molded substrate. The ASIC chip has at least one electrical connection to the at least one RDL at said surface of the molded substrate. Said at least one RDL is configured to provide at least one electrical connection between the EIC chip and the ASIC chip. Integrating an ASIC into the optical module advantageously provides a compact ASIC and optical interconnect package.

In an embodiment, the least one electrical interconnection extending through the molded substrate is a through-mold-via, TMV.

In an embodiment, the molded substrate is one of a molded wafer and a molded panel.

Corresponding embodiments apply equally to the antenna system, baseband unit and packet switch unit described below.

An aspect of the invention provides a method of fabricating an optical module. The method comprises the following steps. A photonic integrated circuit, PIC, chip is provided, the PIC chip having a surface layer and comprising at least one optical circuit. An electronic integrated circuit, EIC, chip is provided, the EIC chip having a surface layer and comprising at least one electrical circuit. The PIC chip and the EIC chip are embedded in a molded substrate having a first surface and a second surface such that the PIC chip surface layer is generally at the first surface of the molded substrate. At least one redistribution layer, RDL, is provided at the first surface of the molded substrate, and at least one electrical connection is provided between the PIC chip and the at least one RDL. At least one opening is provided through the at least one RDL at the first surface of the molded substrate. The at least one opening is for receiving at least one optical fibre connection to the PIC chip. At least one electrical interconnection is provided from the at least one RDL at the first surface of the molded substrate to the second surface of the molded substrate, the at least one electrical interconnection extending through the molded substrate. At least one RDL is provided at the second surface of the molded substrate such that said at least one RDL is connected to the at least one electrical interconnection.

The method advantageously enables the PIC chip to be arranged within the optical module such that an optical fibre can be directly connected to the at least one optical circuit on the PIC chip, through the opening formed in the at least one RDL. This may enable reduced optical loss and better optical efficiency than the described prior art OMCMs in which optical signals are coupled to the back of a PIC chip, through the silicon substrate of the PIC chip. The optical module may have better SI than the described prior art OMCMs. The method may enable an optical module to be fabricated at lower cost and using a simpler fabrication method than the described prior art OMCMs, with better mass producibility and yield.

In an embodiment, the method comprises configuring the PIC chip and the EIC chip as an optical transceiver.

In an embodiment, the EIC chip is embedded in the molded substrate such that its surface layer is generally at the first surface of the molded substrate. At least one electrical connection is provided between the EIC chip and said at least one RDL, which is configured to provide at least one electrical connection between the PIC chip and the EIC chip.

In an embodiment, at least one opening is provided through the at least one RDL at the first surface of the molded substrate. The at least one opening is provided at the PIC chip and is for receiving at least one optical fibre coupler of at least one optical fibre for carrying at least one optical data signal to or from the PIC chip. A further opening is provided through said at least one RDL at the PIC chip for delivery of an optical carrier signal to the PIC chip.

In an embodiment, the method further comprises providing a laser diode for generating the optical carrier signal, locating the laser diode in the further opening, and providing an electrical connection between the laser diode and the EIC chip.

In an embodiment, the further opening is configured to receive a further optical fibre coupler of a further optical fibre for delivery of the optical carrier signal to the PIC chip.

In an embodiment, the method further comprises providing an application specific integrated circuit, ASIC, chip having a surface layer. The ASIC chip is embedded in the molded substrate such that the ASIC chip surface layer is generally at one of the first surface and the second surface of the molded substrate. At least one electrical connection is provided from the ASIC chip to the at least one RDL at said surface of the molded substrate. Said at least one RDL is configured to provide at least one electrical connection between the EIC chip and the ASIC chip.

In an embodiment, the molded substrate is one of a molded wafer and a molded panel.

An aspect of the invention provides an antenna system comprising at least one antenna element, front-end circuitry for the at least one antenna element, at least one application specific integrated circuit, ASIC and at least one optical module. The at least one optical module comprises a photonic integrated circuit, PIC, chip, an electronic integrated circuit, EIC, chip, a molded substrate, redistribution layers, RDLs, and at least one electrical interconnect. The PIC chip has a surface layer and comprises at least one optical circuit. The EIC chip has a surface layer and comprises at least one electrical circuit. The molded substrate has a first surface and a second surface. The PIC chip and the EIC chip are embedded in the molded substrate and the PIC chip is arranged such that its surface layer is generally at the first surface of the molded substrate. At least one redistribution layer, RDL, is provided, located at the first surface of the molded substrate. The PIC chip has at least one electrical connection with the at least one RDL. The at least one RDL has at least one opening provided through it for receiving at least one optical fibre connection to the PIC chip. At least one RDL is provided at the second surface of the molded substrate. At least one electrical interconnection is provided between the at least one RDL at the first surface and the at least one RDL at the second surface, the at least one electrical interconnection extending through the molded substrate. The EIC chip is electrically connected to the at least one ASIC.

In an embodiment, the antenna system further comprises a baseband processing ASIC, at least one further optical module and at least one optical interconnect. The EIC chip of the further optical module is electrically connected to the baseband processing ASIC. The least one optical interconnect is between the PIC of the at least one optical module and the PIC of the at least one further optical module.

An aspect of the invention provides a baseband unit comprising an application specific integrated circuit, ASIC and an optical module. The at least one optical module comprises a photonic integrated circuit, PIC, chip, an electronic integrated circuit, EIC, chip, a molded substrate, redistribution layers, RDLs, and at least one electrical interconnect. The PIC chip has a surface layer and comprises at least one optical circuit. The EIC chip has a surface layer and comprises at least one electrical circuit. The molded substrate has a first surface and a second surface. The PIC chip and the EIC chip are embedded in the molded substrate and the PIC chip is arranged such that its surface layer is generally at the first surface of the molded substrate. At least one redistribution layer, RDL, is provided, located at the first surface of the molded substrate. The PIC chip has at least one electrical connection with the at least one RDL. The at least one RDL has at least one opening provided through it for receiving at least one optical fibre connection to the PIC chip. At least one RDL is provided at the second surface of the molded substrate. At least one electrical interconnection is provided between the at least one RDL at the first surface and the at least one RDL at the second surface, the at least one electrical interconnection extending through the molded substrate. The EIC chip is electrically connected to the ASIC.

An aspect of the invention provides a packet switch unit comprising a packet switch, a plurality of optical modules and a plurality of optical interconnects. Each optical module comprises a photonic integrated circuit, PIC, chip, an electronic integrated circuit, EIC, chip, a molded substrate, redistribution layers, RDLs, and at least one electrical interconnect. The PIC chip has a surface layer and comprises at least one optical circuit. The EIC chip has a surface layer and comprises at least one electrical circuit. The molded substrate has a first surface and a second surface. The PIC chip and the EIC chip are embedded in the molded substrate and the PIC chip is arranged such that its surface layer is generally at the first surface of the molded substrate. At least one redistribution layer, RDL, is provided, located at the first surface of the molded substrate. The PIC chip has at least one electrical connection with the at least one RDL. The at least one RDL has at least one opening provided through it for receiving at least one optical fibre connection to the PIC chip. At least one RDL is provided at the second surface of the molded substrate. At least one electrical interconnection is provided between the at least one RDL at the first surface and the at least one RDL at the second surface, the at least one electrical interconnection extending through the molded substrate. The EIC chip of each optical module is electrically connected to the packet switch. The plurality of optical interconnects are connected to respective PICs of the optical modules.

Embodiments of the invention will now be described, by way of example only, with reference to the accompanying drawings.

### BRIEF DESCRIPTION OF THE DRAWINGS

FIGS. 1 to 6 are illustrations of optical modules according to embodiments of the invention;

FIGS. 7 and 8 are block diagrams illustrating antenna systems according to embodiments of the invention;

FIG. 9 is a block diagram illustrating a baseband unit, BBU, according to an embodiment of the invention;

FIG. 10 is a block diagram illustrating a packet switch unit, PSU, according to an embodiment of the invention; and

FIGS. 11 and 12 illustrate steps of methods according to embodiments of the invention.

### DETAILED DESCRIPTION

The same reference numbers will used for corresponding features in different embodiments.

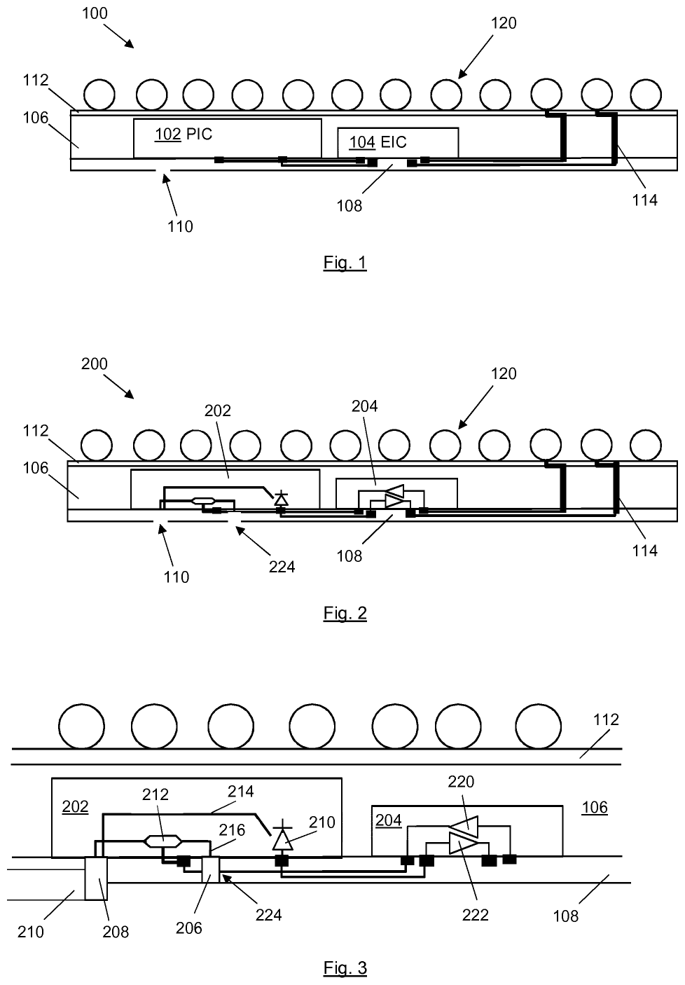

Referring to FIG. 1, an embodiment of the invention provides an optical module 100 comprising a photonic integrated circuit, PIC, chip 102, an electronic integrated circuit, EIC, chip 104, a molded substrate 106, redistribution layers, RDL, 108, 112 and at least one vertical electrical interconnection 114.

The PIC chip has a surface layer and comprises at least one optical circuit. The EIC chip has a surface layer and comprises at least one electrical circuit. The molded substrate has a first surface (bottom as orientated in the Figures) and a second surface (top as orientated in the Figures). The PIC chip and the EIC chip are embedded in the molded substrate and are arranged such that the surface layers of the chips are generally at the first surface of the molded substrate and with a small separation, for example 100 μm or less, between them.

At least one RDL 108 is provided at the first (bottom) surface of the molded substrate, across the molded substrate and the surface layers of the PIC and EIC chips. The PIC chip and the EIC chip each have at least one electrical connection with the RDL 108. The surface layers of the PIC and EIC chips do not need to be perfectly flush with the first surface of the molded substrate but do need to be generally at the same level as that first surface, so that the RDL can be provided across both and electrical connections can be provided between the PIC and EIC chips and the RDL. The RDL 108 is configured to provide electrical connections between the PIC chip and the EIC chip. The small separation between the PIC and the EIC ensures that the electrical connections between them are short and therefore provide good signal integrity, SI.

At least one further RDL 112 is provided at the second (top) surface of the molded substrate.

The at least one RDL 108 at the bottom surface of the substrate has an opening 110 provided through it for receiving an optical fibre connection, such as an optical fibre or an optical fibre ribbon cable, to the at least one optical circuit of the PIC chip.

In this embodiment, two electrical interconnections 114 are provided in the form of through-mold-vias, TMVs, i.e. electrical interconnections extending through the molded substrate. The TMVs 114 connect the at least one RDL 108 provided at the bottom of the molded substrate to the at least one RDL 112 provided at the top of the molded substrate. The TMVs will typically have a length of a few hundred μm, depending on the depth of the molded substrate, so use of TMVs to interconnect the RDLs 108, 112 also ensures good SI performance.

For completeness, FIG. 1 also shows a standard ball grid array, BGA, 120 for providing external electrical connections to the optical module.

In an embodiment, the at least one optical circuit of the PIC chip is provided in a circuit layer of the PIC chip and the at least one electrical circuit of the EIC chip is provided in a circuit layer of the EIC chip. The circuit layers are located close to external surfaces of the chips and are covered with silicon di-oxide, SiO₂, layers, which form the surface layers of the chips. The circuit layers are therefore inner layers of the chips which are provided close to the external surfaces of the chips but are protected by the SiO₂ layers.

In an embodiment, the molded substrate is one of a molded wafer and a molded panel.

In an embodiment, illustrated in FIGS. 2 and 3, the PIC chip 202 and EIC chip 204 of the optical module 200 are configured as an optical transceiver.

The PIC chip 202 comprises two optical circuits: a first optical circuit comprising a first optical waveguide 214 and a photodetector 210; and a second optical circuit comprising second optical waveguide 216 and an optical modulator 212. The input end of the first optical waveguide is configured for connection to an optical fibre coupler 208 of an optical fibre 210, as shown in FIG. 3. The opening 110 in the RDL 108 on the bottom of the molded substrate is configured for receiving the optical fibre coupler.

The RDL 108 at the bottom of the molded substrate 106 has a second opening 224 provided through it, at the PIC chip 202, for delivery of an optical carrier signal to the PIC chip. The second opening 224 is configured for location of a laser diode 206 within the second opening. The RDL 108 is configured to provide an electrical connection between the laser diode and the EIC chip.

The input end of the second optical waveguide 216 is configured to receive an optical carrier signal from the laser diode 206, located in the second opening 224, as shown in FIG. 3. The output end of the second optical waveguide 216 is configured for connection to the optical coupler 208 of the optical fibre 210.

The EIC chip 204 comprises a first electrical circuit comprising an analog driver, for driving the optical modulator 212 and the laser diode 206, and a second electrical circuit comprising an amplifier, for amplifying an output of the photodiode 210.

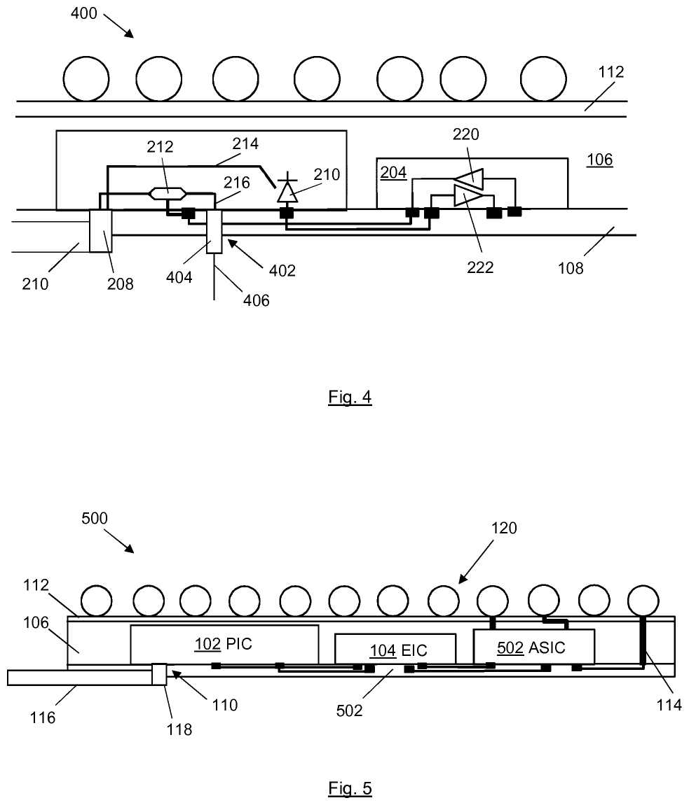

In an alternative embodiment, illustrated in FIG. 4, the second opening in the RDL 108 is configured to receive a further optical fibre coupler 404 of a further optical fibre 406 for delivery of the optical carrier signal to the PIC chip. The optical carrier signal is generated by a separate optical source, not included within the optical module 400.

Referring to FIG. 5, an embodiment of the invention provides an optical module 500 that additionally comprises an application specific integrated circuit, ASIC, chip 502.

The ASIC chip has a surface layer and is embedded in the molded substrate such that its surface layer is at the first (bottom) surface of the molded substrate.

In this embodiment, a single RDL layer is provided at the bottom of the molded substrate in the area of the PIC chip and a plurality, for example three or four, RDL layers 502 are provided at the bottom of the molded substrate in the area of the ASIC chip. The ASIC chip has at least one electrical connection to the RDLs at the bottom of the molded substrate and the RDL layers are configured to provide both at least one electrical connection between the PIC chip and the EIC chip and at least one electrical connection between the EIC chip and the ASIC chip.

The optical module 500 additionally comprises electrical connections from the ASIC chip to the BGA 120, in the form of further TMVs and electrical connections through the RDL 112 on the second (top) surface of the molded substrate.

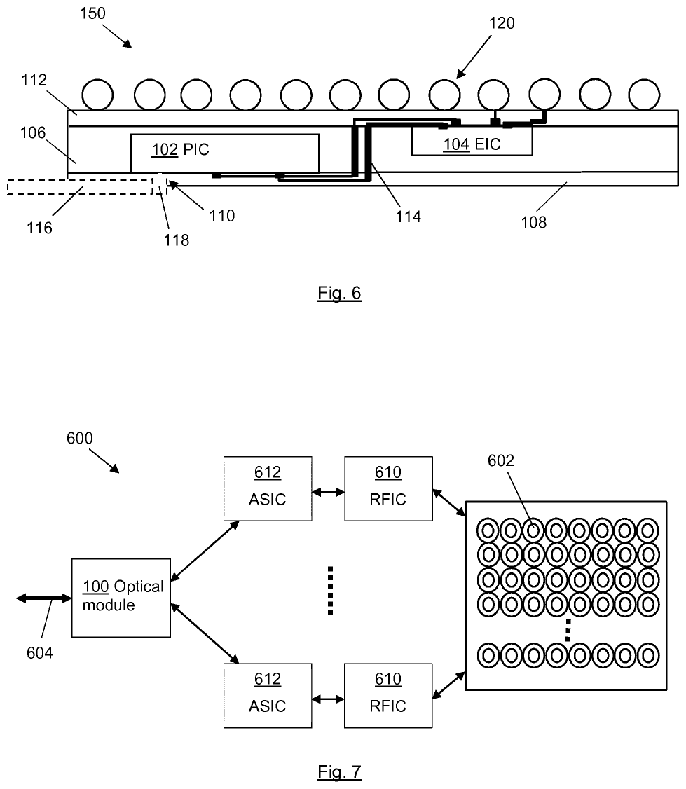

FIG. 6 illustrates an embodiment of the invention in which the optical module 150 has a different arrangement of electrical connections between the PIC 102 and the EIC 104. In this embodiment, the EIC is embedded in the molded substrate with it surface layer at the second (top) surface of the molded substrate. The EIC has at least one interconnection to the RDL 112 and the RDL is configured to provide at least one electrical connection from the EIC chip to the TMVs 114. The electrical connection between the EIC chip and the PIC chip is therefore through both RDLs 108, 112 and the TMVs 114 that interconnect the RDLs.

Corresponding embodiments apply equally to the antenna systems, baseband unit, packet switch unit and methods described below.

A further embodiment of the invention provides an antenna system 600, as illustrated in FIG. 7. The antenna system comprises a plurality of antenna elements 602, a plurality of radio-frequency integrated circuits, RFIC, 610, a plurality of ASICs 612, an optical module 100, 150, 200, 400 and an optical interconnect 604. It will be appreciated that any of the optical modules 100, 150, 200, 400 described above may be used.

The antenna elements 602 are arranged in an array, for example as would be found in a multiple-input multiple-output, MIMO, antenna. The RFICs include analog front-end circuitry for the antenna elements 602. Each RFIC may be interconnected to a respective antenna element 602 or may be interconnected to a plurality of antenna elements 602. The ASICs are digital ASICs configured to perform digital front-end processing. Each ASIC may be interconnected to a respective RFIC or may be interconnected to a plurality of RFICs.

The EIC chip 104 of the optical module 100 is electrically connected to the ASICs.

The optical interconnect 604 may, for example, be an optical fibre cable, an optical fibre ribbon cable or an optically transparent material comprising a plurality of optical waveguides. The optical interconnect 604 comprises an optical coupler which is located through the first opening 110 in the RDL 108 and connected to the optical circuits of the PIC 102, as described above.

FIG. 8 illustrates a further antenna system 650 according to an embodiment of the invention. In this embodiment, the antenna system additionally comprises a further ASIC 652, a further optical module 100, 150, 200, 400 and an optical interconnect 654.

The further ASIC 652 is a baseband processing ASIC and may, for example, be a beamforming ASIC configured to control the shape and direction of one or more beams formed by the outputs of the array of antenna elements 602.

The EIC chip 104 of the further optical module is electrically connected to the baseband processing ASIC.

The optical interconnect 654 may, for example, be an optical fibre cable, an optical fibre ribbon cable or an optically transparent material comprising a plurality of optical waveguides. The optical interconnect 654 is provided with an optical coupler at each end. The optical couplers are located through the first openings 110 in the RDLs 108 of the respective PICs 102 and are connected to the optical circuits of the respective PICs 102, as described above.

The antenna systems 600, 650 may, for example, be active millimetre wave antennas or larger, sub-6 GHz antennas.

In a further embodiment, the RFIC and ASIC may be provided as a single chip combining both analog and digital front-end processing.

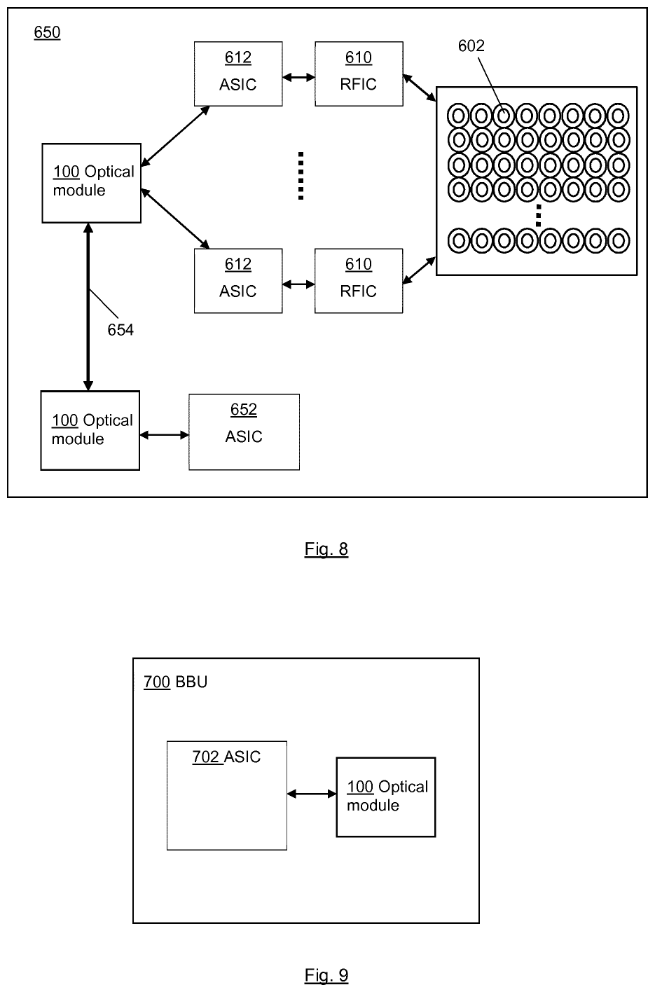

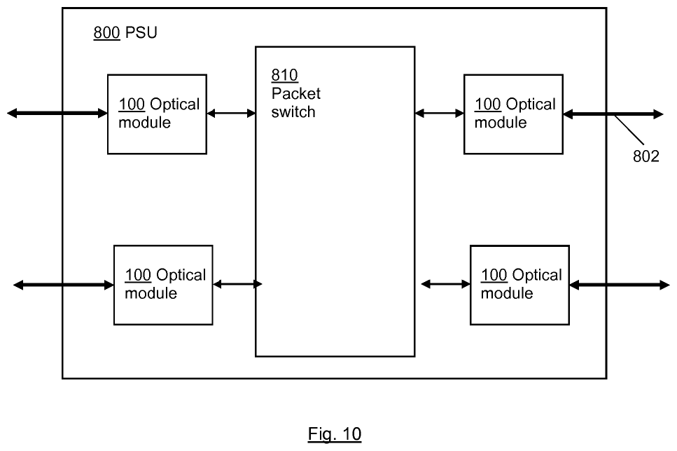

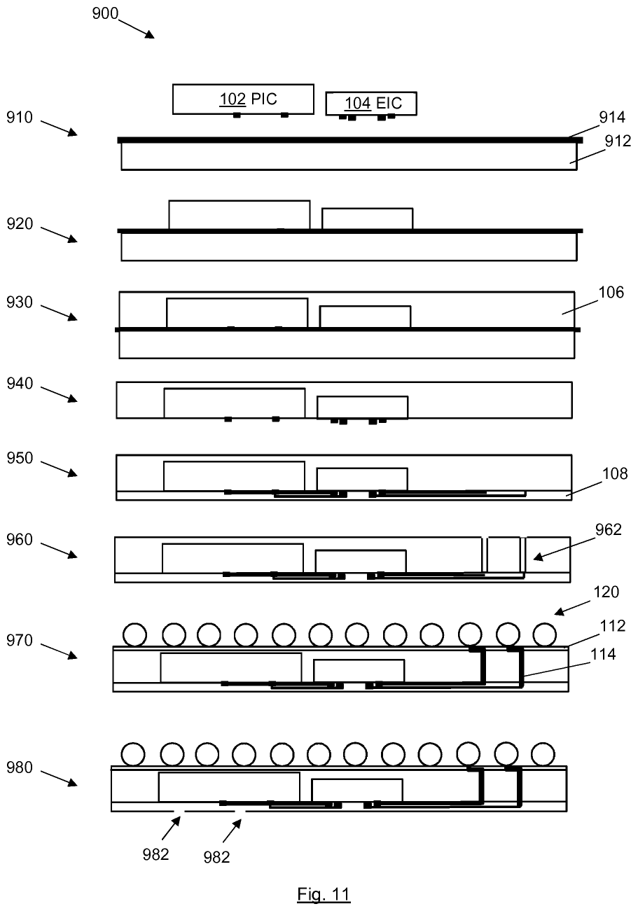

Referring to FIG. 9, an embodiment of the invention provides a baseband processing unit 700 comprising an ASIC 702 and an optical module 100, 150, 200, 400. The EIC chip 104 of the optical module is electrically connected to the ASIC 802.

Referring to FIG. 10, an embodiment of the invention provides a packet switch unit, PSU, 800 comprising a packet switch 810, a plurality of optical modules 100, 150, 200, 400 and a plurality of optical interconnects 802.

The EIC chip 104 of each optical module is electrically connected to the packet switch 810. The optical interconnects 802 are connected to the optical circuits of the PICs 102 of respective optical modules.

The optical interconnects 802 may, for example, be optical fibre cables or an optically transparent material comprising at least one optical waveguide. The optical interconnects 802 are provided with optical couplers which are located through the first opening 110 in the RDL 108 of the respective optical module and connected to the optical circuits of the respective PIC 102, as described above.

The PSU 800 may be used for intra datacenter networking. Next generation electrical packet switch fabrics will comprise 128 input ports and 128 output ports, each having a 50 Gbps data rate, giving the packet switch an aggregate switch capacity of 12.8 Tbps. The multi-Terabit bandwidth is used for interconnection to other packet switches in a multi-stage switch architecture, such as in a Clos network multistage switch, with a link length between packet switches of less than 2 Km. In FIG. 10, the PSU 800 comprises a 12.8 Tbps packet switch chip 810 connected to four optical modules 100, 150, 200, 400, each comprising 32 optical transceivers operable at a data rate of 50 Gbps.

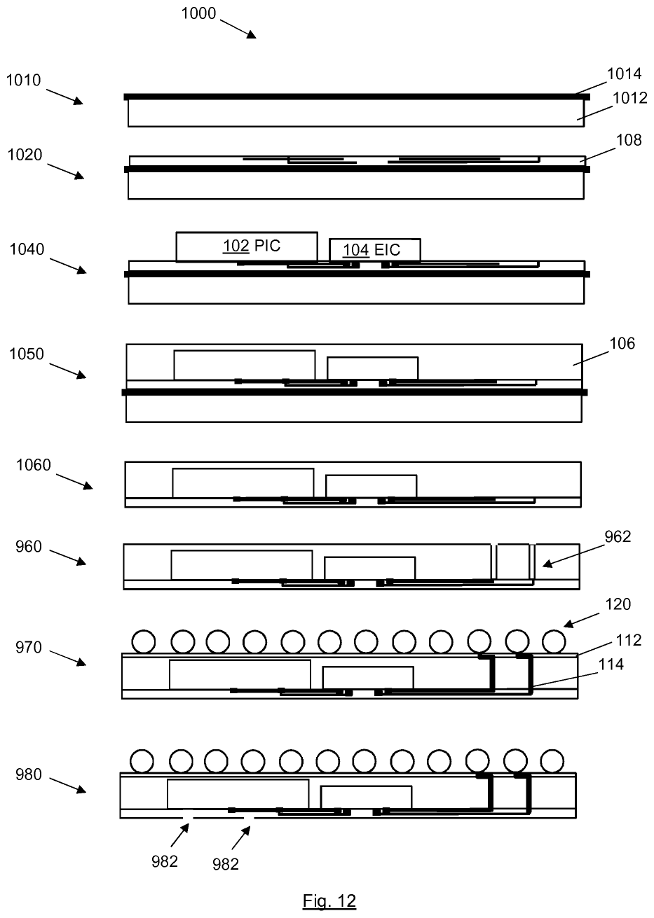

A further embodiment of the invention provides a method 900 of fabricating an optical module, as illustrated in FIG. 11.

The method 900 comprises providing 910 a PIC chip 102, 202 having a surface layer and comprising at least one optical circuit and an EIC chip 104, 204 having a surface layer and comprising at least one electrical circuit. Electrical connection pads or micro-bumps are provided on the PIC chip, connected to electrical devices of the optical circuits, such as the electrodes an optical modulator 212 and photodiode 210, as illustrated in FIGS. 3 and 4. Electrical connection pads or micro-bumps are also provided on the EIC chip, connected to electrical devices of the electrical circuits, such as an analog driver 220 and amplifier 222, as illustrated in FIGS. 3 and 4.

In this embodiment, the PIC chip and the EIC chip are embedded in a molded substrate as follows. The PIC chip and the EIC chip are placed 920 with their respective surface layers on a thermal release tape 914 on a temporary carrier 912; the PIC chip and EIC chip are placed “face-down” on the release tape with a small distance, for example less than 100 μm, between the chips.

Epoxy molding compound is over-molded 930 around the PIC chip and the EIC chip to form a molded substrate 106 and to embed the PIC chip and the EIC chip within the molded substrate, such that the surface layers of the chips 102, 104 are generally at a first surface, the bottom as illustrated in the Figure, of the molded substrate. The thermal release tape and the temporary carrier are then removed 940 and at least one RDL 108 is provided on the bottom of the molded substrate.

The RDL 108 is provided 950 on the molded substrate and across the surface layers of the PIC chip and the EIC chip, such that the electrical connection pads/micro-bumps on the chips are electrically connected to the RDL 108. The RDL may be built up by thin film dielectric and conductor layers. The RDL is configured to provide at least one electrical connection between the PIC chip 102 and the EIC chip 104.

The surface layers of the PIC and EIC chips do not need to be perfectly flush with the first surface of the molded substrate but do need to be generally at the same level as that first surface, so that the RDL can be provided across both and the electrical connection paids/bumps are electrically connected to the RDL.

Through-mold holes 962 are then formed 960 through the molded substrate, connecting the first (bottom) surface of the molded substrate to the second (top) surface of the molded substrate. The holes 962 are then filled or coated with conductive material, such as metal, to form through-mold vias, TMVs, 114.

At least one RDL 112 is then provided 970 on the second (top) surface of the molded substrate, such that the RDL 112 is electrically connected to the TMVs. The RDL may be built up by thin film dielectric and conductor layers. A ball-grid array, 120, is then formed on top of the RDL 112.

Openings 982 are then formed 980 in the at least one RDL 118 on the bottom of the molded substrate.

Although a single optical module can be formed using this method 900, generally a plurality of optical modules will be formed at the same time. Depending upon the size and number of optical modules to be formed, the temporary carrier may have a wafer format or a panel format. A combined molded substrate is therefore formed, of a wafer or panel size, which is then singulated to form individual optical modules.

Using a wafer format temporary carrier may enable reuse of silicon wafer manufacturing equipment. In Fan-out Wafer Level Packaging, FOWLP, forming a molded wafer is currently done for wafers of up to 300 mm in size, so this size of molded substrate could be manufactured using this equipment. Moving to Fan-out Panel Level Packaging, FOPLP, panel sizes for the molded substrate may enable higher productivity and lower costs. Molded substrates manufactured using a temporary carrier having a panel format may have sizes of up to 18″×24″ (45×61 cm), or even larger.

In an embodiment, the PIC chip and the EIC chip are configured as an optical transceiver.

In an embodiment, one of the openings 982 is formed for receiving at least one optical fibre coupler of at least one optical fibre for carrying at least one optical data signal to or from the PIC chip. Another opening 982 is formed for delivery of an optical carrier signal to the PIC chip. An optical fibre coupler of at least one optical fibre may then be connected to the PIC chip.

In an embodiment, the method further comprises providing a laser diode 206 for generating the optical carrier signal. The laser diode is provided within the optical module, located in the further opening 982. The RDL 108 is configured to provide an electrical connection between the laser diode and the EIC chip 104, 204.

In an embodiment, the further opening is configured to receive a further optical fibre coupler of a further optical fibre for delivery of the optical carrier signal to the PIC chip. An optical fibre coupler of a said further optical fibre may then be connected to the PIC chip.

In an embodiment, the step 910 of providing the PIC chip and the EIC chip additionally comprises providing an ASIC chip 502 having a surface layer. The steps 920, 930, 940 are performed to additionally embed the ASIC chip in the molded substrate such that the ASIC chip surface layer is at one of the first (bottom) surface and the second (top) surface of the molded substrate 106. The ASIC chip includes electrical connection pads/micro-bumps and the RDL 118 is provided 950 on the molded substrate and across the surface layers of the PIC chip, the EIC chip and the ASIC chip, such that the electrical connection pads/micro-bumps on the chips are electrically connected to the RDL 108. The RDL is configured to provide at least one electrical connection between the EIC chip 104 and the ASIC chip 502.

Corresponding embodiments apply equally to the alternative method of fabricating an optical module described below.

Referring to FIG. 12, another embodiment of the invention provides an alternative method 1000 of fabricating an optical module in which the RDL layer 108 is formed before the PIC chip 102 and the EIC chip 104 are provided and embedded in the molded substrate 106.

In this embodiment, a thermal release layer 1014 is provided 1010 on a temporary carrier 1012 and then at least one RDL layer 108 is formed 1020 on the release layer. The PIC chip 102 and the EIC chip 104 are then provided 1040 and arranged face-down on the RDL 108, such that the electrical contact pads/micro-bumps of the chips for electrical connections with the RDL.

Epoxy molding compound is over-molded 1050 around the PIC chip and the EIC chip to form a molded substrate 106 and to embed the PIC chip and the EIC chip within the molded substrate, such that the surface layers of the chips 102, 104 are at a first surface, the bottom as illustrated in the Figure, of the molded substrate. The thermal release tape and the temporary carrier are then removed 1060.

The remaining steps of the method 1000 are the same as in the method 900 illustrated in FIG. 11.

It will be appreciated that each of the methods 900, 1000 may be carried out to form a single optical module or may be carried out to form a plurality of optical modules within a shared molded substrate, in which case a further step of substrate singulation is performed to separate the optical modules.

1.-18. (canceled)

19. An optical module comprising:
a photonic integrated circuit (PIC) chip having a surface layer and comprising at least one optical circuit;
an electronic integrated circuit (EIC) chip having a surface layer and comprising at least one electrical circuit;
a molded substrate having a first surface and a second surface, wherein the PIC chip and the EIC chip are embedded in the molded substrate and the PIC chip is arranged such that the surface layer of the PIC chip is generally at the first surface of the molded substrate;
at least one redistribution layer (RDL) located at the first surface of the molded substrate, wherein the PIC chip has at least one electrical connection with the at least one RDL, and wherein the at least one RDL has at least one opening provided through the at least one RDL for receiving at least one optical fibre connection to the PIC chip;
at least one RDL provided at the second surface of the molded substrate; and
at least one electrical interconnection between the at least one RDL at the first surface of the molded substrate and the at least one RDL at the second surface of the molded substrate, the at least one electrical interconnection extending through the molded substrate.

20. The optical module according to claim 19, wherein the PIC chip and the EIC chip are configured as an optical transceiver.

21. The optical module according to claim 19, wherein the EIC chip is embedded in the molded substrate such that the surface layer of the EIC chip is generally at the first surface of the molded substrate and the EIC chip has at least one electrical connection with the at least one RDL located at the first surface of the molded substrate and wherein the at least one RDL at the first surface of the molded substrate is configured to provide at least one electrical connection between the PIC chip and the EIC chip.

22. The optical module according to claim 19, wherein the at least one RDL at the first surface of the molded substrate include through openings for delivery of an optical carrier signal to the PIC chip, and for receiving at least one optical fibre coupler of at least one optical fibre for carrying an optical data signal to or from the PIC chip.

23. The optical module according to claim 22, further comprising a laser diode and wherein the through opening provided through the at least one RDL at the first surface of the molded substrate for delivery of the optical carrier signal to the PIC chip is configured to locate the laser diode therein, and wherein the laser diode has an electrical connection to the at least one RDL at the first surface of the molded substrate and the at least one RDL at the first surface of the molded substrate is configured to provide an electrical connection between the laser diode and the EIC chip.

24. The optical module according to claim 22, wherein the through opening provided through the at least one RDL for delivery of the optical carrier signal to the PIC chip is configured to receive a further optical fibre coupler of a further optical fibre for delivery of the optical carrier signal to the PIC chip.

25. The optical module according to claim 19, further comprising an application specific integrated circuit (ASIC) chip embedded at one of the surface layers of the molded substrate and having at least one electrical connection to the EIC chip provided through one or more of the RDLs.

26. A method of fabricating an optical module, the method comprising steps of:
providing a photonic integrated circuit (PIC) chip having a surface layer and comprising at least one optical circuit;
providing an electronic integrated circuit (EIC) chip having a surface layer and comprising at least one electrical circuit;
embedding the PIC chip and the EIC chip in a molded substrate having a first surface and a second surface such that the PIC chip surface layer is generally at the first surface of the molded substrate;
providing at least one redistribution layer (RDL) at the first surface of the molded substrate;
providing at least one electrical connection between the PIC chip and the at least one RDL at the first surface of the molded substrate;
providing at least one opening through the at least one RDL at the first surface of the molded substrate for receiving at least one optical fibre connection to the PIC chip;
providing at least one electrical interconnection from the at least one RDL at the first surface of the molded substrate to the second surface of the molded substrate, the at least one electrical interconnection extending through the molded substrate; and
providing at least one RDL on the second surface of the molded substrate such that the at least one RDL on the second surface of the molded substrate is connected to the at least one electrical interconnection.

27. The method according to claim 26, wherein the PIC chip and the EIC chip are configured as an optical transceiver.

28. The method according to claim 26, further comprising:
embedding the EIC chip in the molded substrate such that the surface layer of the EIC chip is generally at the first surface of the molded substrate; and
providing at least one electrical connection between the EIC chip and the at least one RDL at the first surface of the molded substrate, wherein the at least one RDL at the first surface of the molded substrate is configured to provide at least one electrical connection between the PIC chip and the EIC chip.

29. The method according to claim 26, further comprising:
providing at least one opening at the PIC chip through the at least one RDL at the first surface of the molded substrate for receiving at least one optical fibre coupler of at least one optical fibre for carrying at least one optical data signal to or from the PIC chip; and
providing a further opening through the at least one RDL at the PIC chip for delivery of an optical carrier signal to the PIC chip.

30. The method according to claim 29, further comprising:
providing a laser diode for generating the optical carrier signal;
locating the laser diode in the further opening; and
providing an electrical connection between the laser diode and the EIC chip.

31. The method according to claim 29, wherein the further opening is configured to receive a further optical fibre coupler of a further optical fibre for delivery of the optical carrier signal to the PIC chip.

32. The method according to claim 26, further comprising:
providing an application specific integrated circuit (ASIC) chip embedded at one of the surface layers of the molded substrate and having at least one electrical connection to the EIC chip provided through one or more of the RDLs.;

33. An antenna system comprising:
at least one antenna element;
front-end circuitry for the at least one antenna element;
at least one application specific integrated circuit (ASIC); and
at least one optical module comprising:
a photonic integrated circuit (PIC) chip having a surface layer and comprising at least one optical circuit;
an electronic integrated circuit (EIC) chip having a surface layer and comprising at least one electrical circuit, the EIC chip being electrically connected to the at least one ASIC;
a molded substrate having a first surface and a second surface, wherein the PIC chip and the EIC chip are embedded in the molded substrate and the PIC chip is arranged such that the surface layer of the PIC chip is generally at the first surface of the molded substrate;
at least one redistribution layer (RDL) located at the first surface of the molded substrate, wherein the PIC chip has at least one electrical connection with the at least one RDL, and wherein the at least one RDL has at least one opening provided through the at least one RDL for receiving at least one optical fibre connection to the PIC chip;
at least one RDL provided at the second surface of the molded substrate; and
at least one electrical interconnection between the at least one RDL at the first surface of the molded substrate and the at least one RDL at the second surface of the molded substrate, the at least one electrical interconnection extending through the molded substrate.

34. The antenna system according to claim 33, further comprising:
a baseband processing ASIC, wherein the EIC chip is electrically connected to the baseband processing ASIC;
at least one further optical module; and
at least one optical interconnect between the PIC chip of the at least one optical module and a PIC chip of the at least one further optical module.

35. A baseband unit comprising:
an application specific integrated circuit (ASIC); and
an optical module comprising:
a photonic integrated circuit (PIC) chip having a surface layer and comprising at least one optical circuit;
an electronic integrated circuit (EIC) chip having a surface layer and comprising at least one electrical circuit, the EIC chip being electrically connected to the at least one ASIC;
a molded substrate having a first surface and a second surface, wherein the PIC chip and the EIC chip are embedded in the molded substrate and the PIC chip is arranged such that the surface layer of the PIC chip is generally at the first surface of the molded substrate;
at least one redistribution layer (RDL) located at the first surface of the molded substrate, wherein the PIC chip has at least one electrical connection with the at least one RDL, and wherein the at least one RDL has at least one opening provided through the at least one RDL for receiving at least one optical fibre connection to the PIC chip;
at least one RDL provided at the second surface of the molded substrate; and
at least one electrical interconnection between the at least one RDL at the first surface of the molded substrate and the at least one RDL at the second surface of the molded substrate, the at least one electrical interconnection extending through the molded substrate.
